(19) United States
(12) Patent Application Publication
(10) Pub. No.: US 2009/0013134 A1
(43) Pub. Date: Jan. 8, 2009

(54) MEMORY APPARATUS AND PROTECTING METHOD THEREOF

(75) Inventors: Hsieh-Chun Chen, Taipei (TW); Tseng-Ho Li, Taipei (TW); Liang-Chen Wu, Taipei (TW); Pei-Yu Huang, Taipei (TW); Yu-Chang Tseng, Taipei (TW); Tsang-Yi Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: TRANSCEND INFORMATION , INC., Taipei (TW)

(21) Appl. No.: 11/773,968

(22) Filed: Jul. 6, 2007

(51) Int. Cl. G06F 12/00

(52) U.S. Cl. 711/152; 711/E12.091

(57) ABSTRACT

A memory apparatus and method for protecting the memory apparatus are provided. The memory apparatus includes a memory unit, a memory control unit, a switch and a control circuit. The memory control unit is used for reading from or writing to the memory unit and has a build-in protection unit. The switch has a lock end and a normal end. The control circuit is coupled between the switch and the memory control unit and is used for detecting the position of the switch. Once the switch is switched to the lock end and the memory apparatus receives a working voltage, the protection unit is automatically enabled by the control circuit to inhibit the memory control unit from reading data from or writing data to the memory unit.

### BACKGROUND OF THE INVENTION

1. Field of the Invention

The present invention generally relates to a memory apparatus, and more particularly to a memory apparatus and a protecting method thereof.

2. Description of Related Art

The increasing popularity of memory cards have gradually replaced the conventional magnetic disks and compact disks. In particular, memory cards are used as data storage devices in digital cameras, digital recorders, MP3 players, personal digital assistant (PDA) and mobile phone. At present, the memory cards in the market include Secure Digital (SD) memory cards, Compact Flash (CF) memory cards, Multi-Media Card (MMC) and so on.

However, most memory cards must go through a specific apparatus or human-machine interface to execute the function of locking or limiting reading/writing and code protection. The specific apparatus or human-machine interface is also used to release the limiting state of the function. At present, the read/write protection function is normally effected by using a non-electricity-carrying switch and a reading equipment (for example, a card reader) is used to detect the position of the switch on the memory card so as to determine whether to enable the read/write function of the memory card or not. If the reading equipment disregards the position of the switch, the read/write protection function of the memory card is virtually non-existent.

On the other hand, the lock function and encoding/decoding operation of memory cards such as the SD memory cards, the CF memory cards or the MMC are must executed through a computer or handheld apparatus. When a computer or a handheld apparatus is not readily available, the lock function of the memory card cannot be executed.

### SUMMARY OF THE INVENTION

Accordingly, the present invention provides a memory apparatus and a protecting method thereof capable of automatically locking the read/write function of the memory apparatus after obtaining a working voltage for the circuit so as to achieve the convenience of data protection.

According to an embodiment of the present invention, a memory apparatus is provided. The memory apparatus includes a memory unit, a memory control unit, a switch and a control circuit. The memory control unit is used for reading from or writing to the memory unit and has a build-in protection unit. The switch has a lock end and a normal end. The control circuit is coupled between the switch and the memory control unit. When the memory apparatus receives a working voltage, the control circuit detects the position of the switch. If the switch is switched to the lock end, then the protection unit is enabled so as to inhibit the memory control unit from reading data from or writing data to the memory unit.

The present invention also provides a mobile apparatus. This mobile apparatus is suitable for a memory apparatus. The mobile apparatus includes a memory apparatus interface and a decoding unit. The decoding unit has an activating code. When the memory apparatus is set in a read/write protection state and coupled to the memory apparatus interface, the decoding unit automatically outputs the activating code to the memory apparatus so as to release the read/write protection state of the memory apparatus.

The present invention also provide a method for protecting a memory apparatus. The memory apparatus has a switch. The switch is used for locking the read/write function of the memory apparatus. The method for protecting the memory apparatus includes the following steps. When a working voltage is received, the memory apparatus is checked to determine whether it is set to a read/write protection state. If the memory apparatus is set to a read/write protection state, the input of an activating code for releasing the read/write protection state of the memory apparatus is requested. If the memory apparatus is set to a normal state, the switch is checked to determine whether it is positioned in a lock end. If the switch is positioned in the lock end, the protection unit of the memory apparatus is enabled to inhibit the reading of data from or the writing of data to the memory apparatus.

The memory apparatus of the present invention has an additional control circuit capable of executing the lock or write protection function of a memory control unit according to the position of a switch so as to achieve fast locking of the read/write function of the memory apparatus. After locking the read/write function of the memory apparatus, the lock function will not be immediately released by switching the switch back to a normal end. Instead, an activating code must be input to release the lock function so as to achieve the data protection function of the memory apparatus effectively.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a farther understanding of the invention, and are incorporated in and constitute a part of this specification. The drawings illustrate embodiments of the invention and, together with the description, serve to explain the principles of the invention.

FIG. 1 is a diagram of a memory apparatus according to an embodiment of the present invention.

FIG. 2 is a flow diagram showing a method for protecting a memory apparatus according to an embodiment of the present invention.

FIG. 3 is a block diagram of a mobile apparatus according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

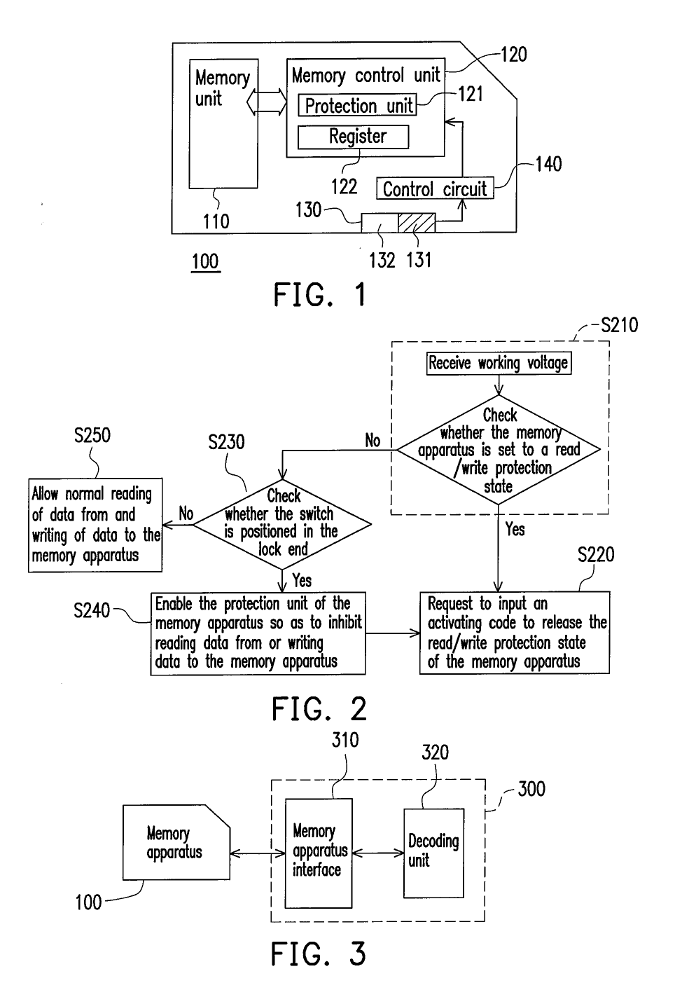

FIG. 1 is a diagram of a memory apparatus according to an embodiment of the present invention. As shown in FIG. 1, the memory apparatus 100 includes a memory unit 110, a memory control unit 120, a switch 130 and a control circuit 140. The memory control unit 120 farther includes a protection unit 121 and a register 122. The switch 130 has a lock end 131 and a normal end 132 for a user to select the position of the switch 130. The control circuit 140 is coupled between the switch 130 and the memory control unit 120. The control circuit 140 determines whether to enable the protection unit 121 so as to inhibit the memory control unit 120 from reading data from or writing data to the memory unit 110 according to the position of the switch 130 (the lock end 131 or the normal end 132).

The memory control unit 120 is used for reading/writing the internal data of the memory unit 110 and has a build-in protection unit 121. The protection unit 121 can disable the read or write function of the memory control unit 120 so as to prevent an external device from reading data from or writing data to the memory unit 110. When the switch 130 is switched to the lock end 131, the control circuit 140 automatically enables the protection unit 121 after receiving a working voltage (for example, when the memory apparatus 100 is connected to an electronic apparatus such as a mobile phone). At this time, the memory apparatus 100 is locked before the electronic apparatus performs any reading so that the electronic apparatus cannot perform any read or write operation. When the switch 130 is switched to the normal end 132, the memory control unit 120 detects the protection unit 121 to determine whether it is enabled. If the protection unit 121 is enabled, the input of an activating code is requested so as to release the protection unit 121. If the protection unit 121 is not enabled, the memory control unit 120 is allowed to read data from or write data to the memory unit 110.

The memory control unit 120 can obtain information regarding the position of the switch 130 through the control circuit 140 and then perform corresponding actions. The control circuit 140 also automatically determines whether to enable the protection unit 110 after receiving the required working voltage according to the position of the switch 130. In other words, when the user changes the position of the switch 130, the memory control unit 120 and the control circuit 140 automatically act after the memory apparatus 100 receiving the working voltage and determine whether to lock the memory apparatus 100. The working voltage can be obtained through a build-in power source such as a build-in micro solar-powered cell or mechanical-powered battery of the memory apparatus 100, or an external power source such as the power obtained through a memory apparatus interface (a connecting interface) or specific connecting pins. In general, when the memory apparatus 100 is connected to an electronic apparatus (for example, a mobile phone), the memory apparatus 100 is able to obtain the required working voltage. Since the control circuit 140 in the present embodiment can be implemented through a hardware circuit or a single chip (through firmware or perform an expansion function directly by the memory control unit 120) so as to achieve the aforementioned effects, a detailed description is not repeated.

In the present embodiment, the memory apparatus 100 can be a SD memory card, a CF memory card or a MMC. In the specifications of most memory cards (for example, the SD memory cards or the CF memory cards), the memory control unit 120 includes a build-in lock command or a write protection command that normally built by firmware. These lock or write protection firmware are the protection unit 121 described in the present embodiment. In another embodiment of the present invention, the protection command of the protection unit 121 can also be designed by a designer or implemented using a hardware circuit. The present invention is not limited to the build-in protection command in the specification of the memory apparatus 100.

In other words, the aforementioned protection unit 121 can include a lock function and a write protection function. The control circuit 140 can select whether to execute the lock function or the write-protection function according to a preset value. The preset value can be pre-determined by the user according to the requirements so as to select the form of data protection performed on the memory apparatus 100. If the lock function of the protection unit 121 is enabled, the memory control unit 120 is inhibited from reading data from or writing data to the memory unit 110. If the write protection function of the protection unit 121 is enabled, the memory control unit 120 is only inhibited from writing data to the memory unit 110.

When the memory apparatus 100 is locked, the memory control unit 120 will request the user to input an activating code (for example, 0000) so as to release the lock state (read/write protection state). The activating code can be pre-determined and saved in the register 122 or a specific block of the memory unit 110.

In the foregoing embodiment, the memory apparatus 100 of the present invention is illustrated using a memory card as an example. However, the memory apparatus 100 in the embodiments of the present invention is not limited to a memory card, but can be build-in non-volatile memory apparatus such as portable hard disk or MP3 (multi-media) player or personal digital assistant.

### Second Embodiment

According to the first embodiment, a method for protecting a memory apparatus 100 can be summarized and described as follows. FIG. 2 is a flow diagram showing a method for protecting a memory apparatus according to an embodiment of the present invention. As shown in FIGS. 1 and 2, in step S210, the memory control unit 120 detects whether the protection unit 121 is enabled after the memory apparatus 100 receiving a working voltage so as to check whether the memory apparatus 100 is set to a read/write protection state. If the protection unit 121 is enabled, indicating that memory apparatus 100 is set to a read/write protection state, step S220 is executed. If the protection unit 121 is not enabled, indicating that the memory apparatus 100 is set to a normal state, step S230 is executed.

In step S220, the memory apparatus 100 is set to the read/write protection state. At this time, the memory apparatus 100 will initiate a request to input an activating code to release the function of the protection unit 121 of the memory control unit 120 so that the memory apparatus 100 returns to a normal data read/write state. In step S230, the memory apparatus 100 is set to a normal state. At this time, the control circuit 140 detects whether the switch 130 is positioned in the lock end 131. If the switch 130 is positioned in the lock end 131, step S240 is executed. However, if the control circuit 140 detects that the switch 130 is positioned in the normal end 132, step S250 is executed.

In step S240, the switch 130 is positioned in the lock end 131. At this time, the control circuit 140 will enable the protection unit 121 in the memory control unit 120 so as to inhibit any data from being read from or being written to the memory apparatus 100. As a result, the data inside the memory apparatus 100 are protected. Once the protection unit 121 is enabled, the memory apparatus 100 enters the read/write protection state. Next, in step S220, the input of an activating code for releasing the read/write protection state of the memory apparatus 100 is requested. In step 250, the switch 130 is positioned in the normal end 132. This indicates that the memory apparatus 100 is set to the normal state so that reading data from and writing data to the memory apparatus 100 is allowed.

### Third Embodiment

From another point of view, the present invention also provides a mobile apparatus suitable for the memory apparatus 100 as shown in FIG. 3. FIG. 3 is a block diagram of a mobile apparatus according to another embodiment of the present invention. The mobile apparatus 300 includes a memory apparatus interface 310 and a decoding unit 320. The decoding unit 320 has an activating code needed for releasing the lock function of the memory apparatus 100. If the memory apparatus 100 is set to the read/write protection state, the decoding unit 320 automatically outputs the activating code to the memory apparatus 100 so as to release the read/write protection state when the memory apparatus 100 is coupled to the memory apparatus interface 310.

Therefore, combining the mobile apparatus 300 with the memory apparatus 100 in the foregoing embodiment not only enhances data protection of the memory apparatus 100, but also avoids inconveniencing the user. The user only has to set up a corresponding activating code in the mobile apparatus 300 and the memory apparatus 100, the mobile apparatus 300 can automatically release the read/write protection state of the memory apparatus. On the other hand, other mobile apparatus may request to input an activating code before reading data from or writing data to the memory apparatus 100 is allowed.

In summary, the present invention includes at least the following advantages:

1. When the memory apparatus receives a working voltage, the read/write function of the memory apparatus is automatically locked so as to achieve automatic locking function of the memory apparatus.

2. After locking the read/write function of the memory apparatus, regardless of whether the switch is switched to a lock end or a normal end, the memory apparatus is still set to the read/write protection state. To release the locked read/write function in the memory apparatus, an activating code is required so that data protection can be effectively achieved.

3. Since read/write operation is limited by a non-structural means, the complexity of reading/writing equipment terminal can be reduced or the problem caused by having a faulty detecting mechanism can be removed.

4. The lock function can be executed without having to communicate through a human-machine interface.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memory apparatus, comprising:
a memory unit;
a memory control unit, used for reading data from or writing data to the memory unit and having a build-in protection unit;
a switch, having a lock end and a normal end; and
a control circuit, coupled between the switch and the memory control unit;
wherein the control circuit detects the position of the switch after the memory apparatus receiving a working voltage, and when the switch is positioned in the lock end, the protection unit is enabled to inhibit the memory control unit from reading data from or writing data to the memory unit.

2. The memory apparatus according to claim 1, wherein the protection unit comprises a lock function and a write protection function, and when the memory apparatus receives the working voltage, the control circuit enables the lock function or the write protection function of the protection unit according to a preset value.

3. The memory apparatus according to claim 2, wherein the memory control unit is inhibited from reading data from or writing data to the memory unit when the lock function is enabled, and the memory control unit is inhibited from writing data to the memory unit when the write protection function is enabled.

4. The memory apparatus according to claim 1, wherein the memory control unit detects whether the protection unit is enabled or not when the switch is switched to the normal end, and when the protection unit is enabled, an input of an activating code is requested to release the protection unit, and when the protection unit is not enabled, the memory control unit is allowed to read data from or write data to the memory unit.

5. The memory apparatus according to claim 4, wherein the memory control unit comprises:
a register, used for saving the activating code.

6. The memory apparatus according to claim 1, wherein the memory apparatus receives the working voltage through a memory apparatus interface.

7. The memory apparatus according to claim 1, wherein the working voltage is provided by a build-in power source of the memory apparatus.

8. The memory apparatus according to claim 7, wherein the build-in power source comprises a micro solar-powered cell or a mechanical-powered battery.

9. The memory apparatus according to claim 1, wherein the working voltage is provided by an external device.

10. The memory apparatus according to claim 9, wherein the external device comprises a mobile phone.

11. The memory apparatus according to claim 1, wherein the memory apparatus comprises a Secure Digital memory card, a Compact Flash memory card, a Multi-Media Card or a portable hard disk.

12. The memory apparatus according to claim 1, wherein the memory apparatus comprises a non-volatile memory apparatus inside an MP3 player or a personal digital assistant.

13. A mobile apparatus adapted to a memory apparatus, wherein the memory apparatus is set in a read/write protection state, the mobile apparatus comprising:
a memory apparatus interface; and
a decoding unit, having an activating code;
wherein the decoding unit automatically outputs the activating code to the memory apparatus so as to release the read/write protection function of the memory apparatus when the memory apparatus is coupled to the memory apparatus interface.

14. The mobile apparatus according to claim 13, wherein the memory apparatus comprises:
a memory unit;
a memory control unit, used for reading data from or writing data to the memory unit and having a build-in protection unit;
a switch, having a lock end and a normal end; and
a control circuit, coupled between the switch and the memory control unit;
wherein the control circuit detects the position of the switch after the memory apparatus receiving a working voltage, and when the switch is positioned in the lock end, the protection unit is automatically enabled into a read/write protection state and inhibits data reading from or writing to the memory unit.

15. A method for protecting a memory apparatus, wherein the memory apparatus has a switch for locking the read/write function of the memory apparatus, the protecting method comprising:
checking whether the memory apparatus is set to a read/write protection state after receiving a working voltage;
requesting an input of an activating code to release the read/write protection state of the memory apparatus if the memory apparatus is set to the read/write protection state;
checking whether the switch is positioned in a lock end if the memory apparatus is set to a normal state; and
enabling the protection unit in the memory apparatus so as to inhibit reading data from or writing data to the memory apparatus if the switch is positioned in the lock end.

16. The protecting method according to claim 15, wherein after enabling the protection unit in the memory apparatus, further comprising:
requesting an input of the activating code so as to release the read/write protection state of the memory apparatus.

17. The protecting method according to claim 15, wherein the step of enabling the protection unit in the memory apparatus so as to inhibit reading data from or writing data to the memory apparatus if the switch is positioned in the lock end, further comprising:
allowing normal reading of data from or normal writing of data to the memory apparatus if the switch is positioned in a normal end.

18. The protecting method according to claim 15, wherein the memory apparatus comprises a Secure Digital memory card, a Compact Flash memory card, a Multi-Media Card or a portable hard disk.

19. The protecting method according to claim 15, wherein the memory apparatus comprises non-volatile memory apparatus inside an MP3 player or a personal digital assistant.
